(19) United States
(12) Patent Application Publication
(10) Pub. No.: US 2018/0040062 A1
(43) Pub. Date: Feb. 8, 2018

(54) RESOURCE TRACKING AND UTILIZATION SYSTEM

(71) Applicant: BANK OF AMERICA CORPORATION, Charlotte, NC (US)

(72) Inventors: Katherine Dintenfass, Lincoln, RI (US); Victoria L. Dravneek, Charlotte, NC (US); Alicia C. Jones-McFadden, Fort Mill, SC (US); Matthew Hsieh, Charlotte, NC (US)

(21) Appl. No.: 15/231,326

(22) Filed: Aug. 8, 2016

(51) Int. Cl. G06Q 40/02; H04L 29/06; G06F 21/62; G06Q 20/10

(52) U.S. Cl. CPC G06Q 40/02; G06Q 20/102; H04L 63/102; G06F 21/6254

(57) ABSTRACT

Systems, computer program products, and methods are described herein for resource tracking and utilization. The present invention is configured to extract resource information related to a user from an entity server, extract resource information related to a plurality of users from the entity server, display the information associated with an event to the user, wherein the displayed information is based on the retrieved resource information related to the plurality of users and perform a series of steps based on the information associated with the event.

### BACKGROUND

Users of an entity often make life changes and experience life events making it difficult to manage available resources. Improper utilization of resources may result in instability and inefficacy. There is a need for a system to track, manage, and utilize the resources to help the users of an entity through the transition.

### SUMMARY

The following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

In general terms, embodiments of the present invention address the above needs and/or achieve other advantages by providing apparatuses (e.g., a system, computer program product and/or other devices) and methods for resource tracking, management and utilization. The present invention gathers information about the user and determines other users similarly situated to the user. The system accesses information about those user' spending and saving habits and how those users are tracking their goals and provides information to the user. The system may recognize (i.e., make an educated guess, use confidence scoring) that the user is making a life change based on information available to the system (and in some cases confirm that with the user or simply ask the user to input what life changes are coming) and then provide information to the user about other users who have gone through similar life changes. The bank can ask a customer what the purpose of their account is and use that information as input to this system. System provides a customer a holistic view of their entire financial life and provides vision into what the customer's life would look like if the customer did different things. For example, the model may look at another user's (or multiple users) similarly situated to the user and who went through similar situation(s) with different results. The system can present those different results to the user and let the user know what actions led to the end results. Embodiments of the invention are directed to an apparatus comprising a web-based communication interface, a memory device storing an application and a processing device operatively coupled to the memory device wherein the processing device is configured to execute computer-readable program code to extract from an entity server, profile information and resource information related to a user associated with an entity, wherein the information is extracted with authorization from the user; predict the occurrence of an event based on the extracted information related to the user; retrieve from a customized database table in the entity server, resource information related to a plurality of users associated with the entity matching profile information of the user, wherein the information is extracted with authorization from the plurality of users, wherein the identity of the plurality of users is anonymized by deliberate non-query of identity information from the customized database table; identify a one or more course of actions for managing resources to handle the event based on the resource information retrieved related to the plurality of users; display, via a graphical user interface, information associated with the event based on the retrieved resource information related to the user, wherein the information associated with the event is type of the event; determine that the information displayed is applicable to the user and transmit a trigger to the entity server; and in response to receiving the trigger based on determining that the information displayed is applicable to the user, display the identified one or more course of actions; prompt, via the computer processing device, the user to select a course of action from the one or more course of actions provided, wherein prompting the user comprises causing the device associated with the user to display a graphical user interface that is configured to receive the course of action from the user.

In some embodiments, in response to receiving the course of action from the user, initiating the course of action by performing a series of steps associated with the course of action.

In some embodiments, the processing device is further configured to execute computer-readable program code to display the outcome of the one or more course of actions.

In some embodiments, the processing device is further configured to execute computer-readable program code to recognize that the user is making a life change based on the identified information related to the user; and provide information to the user about the plurality of users who have experienced the life change.

In some embodiments, confidence scoring is used to recognize that the user is making the life change.

In some embodiments, the processing device is further configured to execute computer-readable program code to forecast a series of steps to be performed based on identifying that the user is making the life change.

In some embodiments, the entity retrieves information from the user by generating a questionnaire to identify a purpose of the account.

In some embodiments, the processing device is further configured to execute computer-readable program code to provide a holistic view of the financial life of the user.

In some embodiments, the processing device is further configured to execute computer-readable program code to identify a mortgage payment scenario, based on the extracted resource information related to the user; identify a group of the plurality of users, matching the profile of the user; identify the mortgage payment scenario faced by the plurality of users and a series of measures executed by the plurality of users to handle the mortgage payment scenario from the resource information related to the plurality of users; prompt to the user, via a graphical user interface the series of measures executed by the plurality of users to handle the mortgage payment.

### BRIEF DESCRIPTION OF THE DRAWINGS

Having thus described some embodiments of the present invention in general terms, reference will now be made to the accompanying drawings, where:

FIG. 1 presents a block diagram illustrating resource tracking and utilization system in accordance with embodiments of the invention;

FIG. 2 provides a block diagram illustrating the financial system server of FIG. 1, in accordance with embodiments of the invention;

FIG. 3 provides a block diagram illustrating the user's computing device of FIG. 1, in accordance with embodiments of the invention;

FIG. 4 provides a block diagram illustrating the user's mobile device of FIG. 1, in accordance with embodiments of the invention;

FIG. 5 illustrates a process flow for providing the user of a financial institution, event related data extracted from data associated with a plurality of users matching the profile of the user; and

FIG. 6 illustrates process flow for forecasting a series of steps to be performed based on identifying that the user is making a life change.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” or “financial entity” or “entity” may include any organization that processes financial transactions including, but not limited to, banks, credit unions, savings and loan associations, investment companies, stock brokerages, asset management firms, insurance companies and the like. Furthermore, embodiments of the present invention use the term “user” or “customer.” It will be appreciated by someone with ordinary skill in the art that the user or customer may be a customer of the financial institution or a potential customer of the financial institution.

In accordance with embodiments of the invention, an “account” is the relationship that a customer has with an entity, such as a financial institution. Examples of accounts include a deposit account, such as a transactional account (e.g., a banking account), a savings account, an investment account, a money market account, a time deposit, a demand deposit, a pre-paid account, a credit account, a debit/deposit account, a non-monetary user profile that includes information associated with the user, or the like. The account is associated with and/or maintained by the entity.

As used herein, the term “resource” will generally refer to objects, products, goods, commodities, services, and the like, and/or the ability and opportunity to view, access and use the same. Some example implementations herein contemplate property held by a user, including property that is stored and/or maintained by a third party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. Examples of resources that may not necessarily be associated with accounts may be particularized goods, such as distinct pieces of furniture, equipment, or other valuables, or the like. Similarly, “funds” or “available balance” refer to types of resources. For example, the term “fund” may be used to refer to one or more sets of monetary resources available to a user, and may also be referred to as an available balance, a collected balance, good funds, and usable funds.

Many of the example embodiments and implementations described herein contemplate interactions engaged in by a resource user with a computing device and/or one or more resource access communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, user's computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users. An “entity” may be a financial institution, a third party provider, and the like. A “user device” is any device that is associated with the user of the entity. For example, user device may be a computing device, mobile device and the like.

Embodiments of the present invention provide a system, a method and a computer program product for extracting information about a user of a financial institution and predicts the occurrence of an event based on the extracted information. The system is configured to access information about the resources and retrieve information about the practices implemented by the plurality of users, anonymizing the identity of the plurality of users. In some embodiments, the system also identifies the major life events faced by a plurality of users, collects and stores the data related to the major life events. The system identifies the data related to the user already stored in the memory device associated with the life event, displays the retrieved information to the user, determines that the information displayed to the user is related to the information requested by the user and displays one or more course of actions that the user can choose to handle the life event and/or a life change. The system in response to receiving the course of action from the user, performs a series of steps to initiate the course of action. In some embodiments the system is further configured to predict the occurrence of a life event and/or a life change by using confidence scoring, notify the user about the life event and/or a life change and display one or more course of actions for managing resources based on the retrieved resource information related to a plurality of users. In some embodiments the system also provides the user a holistic view of their entire financial life and a vision into what user's life would look like if the user had taken a different course of action.

The system provides one or more course of actions for managing resources matching the profile of the user, improving the efficiency of the processor by eliminating the process of reallocation of resources. The system also identifies the major life events and/or life changes and stores the resource information related to the events and/or changes to reduce the processing time of compiling the one or more course of actions for managing resources after predicting the occurrence of an event.

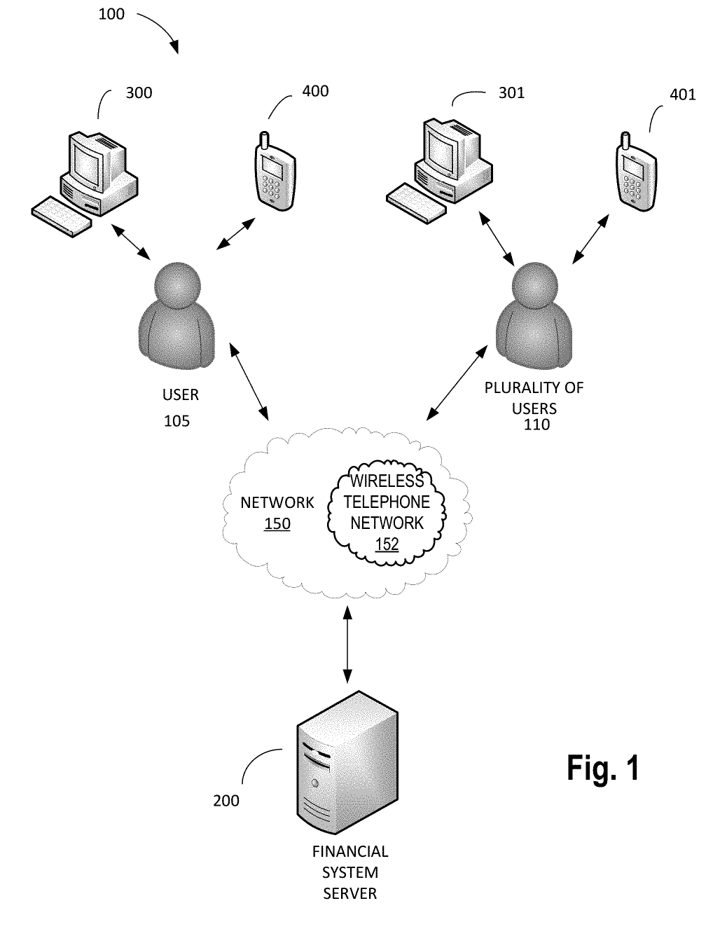

FIG. 1 presents an exemplary block diagram of the system environment 100 for implementing the process flows described herein in accordance with embodiments of the present invention. As illustrated, the system environment 100 includes a user 105, a plurality of users 110 and a network 150. A user of the system may be an individual account holder, an agent of the account holder, a user of a financial institution, or any other entity capable of maintaining a financial account.

The environment 100 includes a plurality of user devices 300, 301, 400, and 401. The user devices 300, 301, 400, and 401 may comprise any machine, apparatus, system or the like that may be connected to and communicate with other devices over network 150. At least one of the devices may comprise a mobile device 400 for use by the user 105. The mobile device 400 may be any portable device that employs a processor and memory and can perform computing functions, and that may be connected to or access network 150. As used herein, the mobile device 400 may comprise any mobile communication device, such as a cellular telecommunications device (i.e., a cell phone or mobile phone), personal digital assistant (PDA), a mobile Internet accessing device, or other mobile device. The mobile device 400 may be connected to a network 150 by wireless access such as wireless local area network (WLAN) such as Wi-Fi based on the Institute of Electrical and Electronics Engineers' (IEEE) 802.11 standards, Bluetooth short-wavelength UHF radio waves in the ISM band from 2.4 to 2.485 GHz or other wireless access technology.

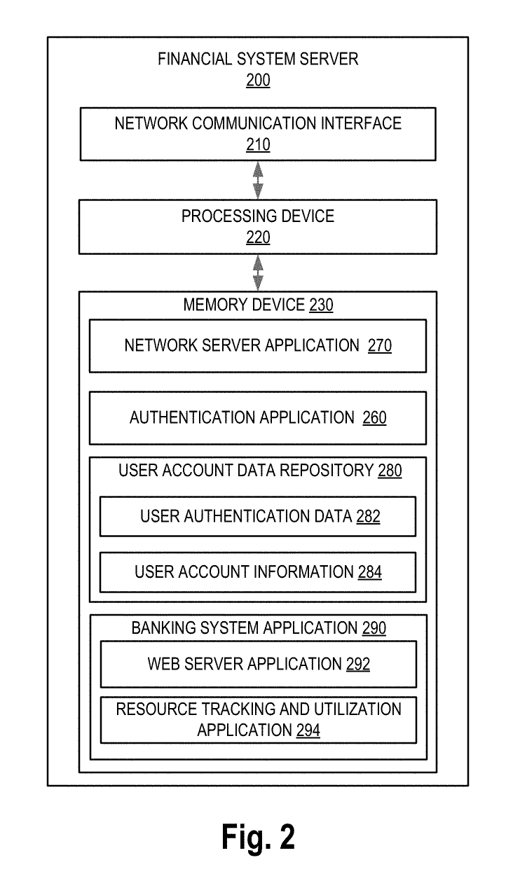

The computing device 300 of the user 105 may be any device that employs a processor and memory and can perform computing functions, such as a personal computer. The mobile device 400 or the user device of the user 105 can be any device that employs a processor and memory and may refer to mobile phones, user's computing devices, tablet computers, wearable devices, and/or any portable electronic device capable of receiving and/or storing data therein. The computing devices 300, and 301 and mobile devices 400, and 401 of user 105 and plurality of users 110 are configured to communicate over a network 150 with a financial system server 200. The computing device, mobile device, and financial system server are described at a greater detail below with reference to FIGS. 2-4.

The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

In general, the computing device 300 is configured to connect with the network 150 to allow user 105 to access his/her online banking account with the financial system server 200. The computing device 300 is also configured to connect with network 150 allow the user 105 to access the third party system such as an online domain. The financial system server 200 involves authentication of a user 105 in order to access the user's account in the financial system server 200. For example, the financial system server 200 is a system where a user 105 logs into his/her account such that the user or other entity can access data that is associated with the user. For example, in one embodiment of the invention, the financial system server 200 is an online banking system maintained by a financial institution. In such an embodiment, the user 105 can use the computing device 300 or mobile device 400 to log into the financial system server 200 to access user's online banking account. Logging into the financial system server 200 generally requires user 105 authenticate his/her identity using a user name, a passcode, a cookie, a biometric identifier, a private key, a token, and/or another authentication mechanism that is provided by the user 105 to the financial system server 200 via the computing device 300 or mobile device 400. In some embodiments the authentication system may be a tiered system that may require different levels of authentication based on conditions such as, for example, previous activity of the user over the network 150. For example, the tiered authentication system may have three levels of authentication—hard, medium and soft. Hard authentication may require that the user input a high level of authentication information such as a combination of password, user identification, answer to challenge questions, biometrics, random key number or the like. A hard authentication may be required when the user logs on from an unrecognized user device or where the user activity is not recognized by the system. A medium authentication level may require only a user identification and password. A medium level of authentication may be required where, for example, the user 105 has already logged-in to the mobile device 400 or computing device 300 using an authentication procedure for the device such as a thumbprint or password. A soft authentication may require only a user identification such as user name. A soft level of authentication may be used, for example, where the user 105 has already logged-in to the mobile device 400 or computing device 300 using an authentication procedure for the device such as a thumbprint or password and the user has performed activities on the user device 300 or 400 that are recognized as “normal” activity for that user and/or the user device 300 or 400 is in a recognized location for that user 105. Thus, the level of authentication required for accessing the banking application, whether online, mobile or in person, may be adjusted based on conditions, activity, functions or information received about or from the user 105.

The computing device 301 is configured to connect with the network 150 to allow plurality of users 110 to access his/her online banking account with the financial system server 200. The computing device 301 is also configured to connect with network 150 allow the plurality of user 110 to access the third party system such as an online domain. The financial system server 200 involves authentication of a plurality of user 110 in order to access the account in the financial system server 200. For example, the financial system server 200 is a system where a plurality of users 110 logs into his/her account such that the plurality of users 110 or other entity can access data that is associated with the plurality of users 110. For example, in one embodiment of the invention, the financial system server 200 is an online banking system maintained by a financial institution. In such an embodiment, the plurality of users 110 can use the computing device 301 or mobile device 401 to log into the financial system server 200 to access online banking account. Logging into the financial system server 200 generally requires plurality of users 110 authenticate his/her identity using a user name, a passcode, a cookie, a biometric identifier, a private key, a token, and/or another authentication mechanism that is provided by the plurality of users 110 to the financial system server 200 via the computing device 301 or mobile device 401. In some embodiments the authentication system may be a tiered system that may require different levels of authentication based on conditions such as, for example, previous activity of the user over the network 150. For example, the tiered authentication system may have three levels of authentication—hard, medium and soft. Hard authentication may require that the user input a high level of authentication information such as a combination of password, user identification, answer to challenge questions, biometrics, random key number or the like. A hard authentication may be required when the user logs on from an unrecognized user device or where the user activity is not recognized by the system. A medium authentication level may require only a user identification and password. A medium level of authentication may be required where, for example, the one of the plurality of users 110 has already logged-in to the mobile device 401 or computing device 301 using an authentication procedure for the device such as a thumbprint or password. A soft authentication may require only a user identification such as user name. A soft level of authentication may be used, for example, where the user has already logged-in to the mobile device 401 or computing device 301 using an authentication procedure for the device such as a thumbprint or password and the user has performed activities on the user device 401 or 301 that are recognized as “normal” activity for that user and/or the user device 301 or 401 is in a recognized location for that user. Thus, the level of authentication required for accessing the banking application, whether online, mobile or in person, may be adjusted based on conditions, activity, functions or information received about or from one of the plurality of users 110.

The financial system server 200 extracts resource information about users of the financial institution. In some embodiments, the extracted information may be the financial activity and the profile of the user 105 and plurality of users 110. For example, the profile of the user may include monthly income, profession, job industry, location, age group, and the like. In some embodiments, the system recognizes the common life events and/or life changes by the user 105 and the plurality of users 110 and extracts information about the measures taken by the users for managing resources to handle the events. The extracted information is sorted according to the profile of the users in the database of the financial system server 200. The financial system server 200 is in network communication with the mobile devices 400, 401 and computing devices 300, 301 of the user 105 and plurality of users 110 of the financial institution. For example, the financial system server receives a request from the device associated with the user and provides the requested information to the user by accessing the database containing the retrieved information.

FIG. 2 provides a block diagram illustrating the financial system server 200, in greater detail, in accordance with embodiments of the invention. As illustrated in FIG. 2, in one embodiment of the invention, the financial system server 200 include one or more processing devices 220 operatively coupled to a network communication interface 210 and a memory device 230. In certain embodiments, the financial system server 200 are operated by a first entity, such as a financial institution, while in other embodiments, the financial system server 200 are operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the financial system server 200 described herein. For example, in one embodiment of the financial system server 200, the memory device 230 includes, but is not limited to, a network server application 270, an authentication application 260, a user account data repository 280 which includes user authentication data 282 and user account information 284, a banking system application 290 which includes a web server application 292, a resource tracking and utilization application 294 and other computer-executable instructions or other data. The computer-executable program code of the network server application 270, the authentication application 260, or the banking system application 290 may instruct the processing device 220 to perform certain logic, data-processing, and data-storing functions of the financial system server 200 described herein, as well as communication functions of the financial system server 200.

In one embodiment, the user account data repository 280 includes user authentication data 282 and user account information 284. The network server application 270, the authentication application 260, and the banking system application 290 are configured to invoke or use the user account information 284, and the user authentication data 282, when authenticating a user to the financial system server 200.

As used herein, a “communication interface” generally includes a modem, server, transceiver, and/or other device for communicating with other devices on a network, and/or a user interface for communicating with one or more users. Referring again to FIG. 2, the network communication interface 210 is a communication interface having one or more communication devices configured to communicate with one or more other devices on the network 150, such as the mobile device 400, and the personal computing device 300. The processing device 220 is configured to use the network communication interface 210 to transmit and/or receive data and/or commands to and/or from the other devices connected to the network 150.

The resource tracking and utilization application 294 causes the processing device 220 to extract the resource data associated with the user 105 from the user account data repository 280 and analyze the data to predict occurrence of an event. The resource tracking and utilization application 294 then causes the processor to identify one or more course of actions for managing resources implemented by a plurality of users 110 matching the profile of user 105 from the resource information related to a plurality of users 110 present in the user account data repository 280 and transmit the extracted data via the network communication interface 210 to display the one or more course of actions on the user's computing device 300 or the mobile device 400. In some embodiments, the one or more course of actions related to common life events and/or life changes are stored in the memory device 230 of the financial system server 200 reducing the processing time of displaying the one or more course of actions to the user 105.

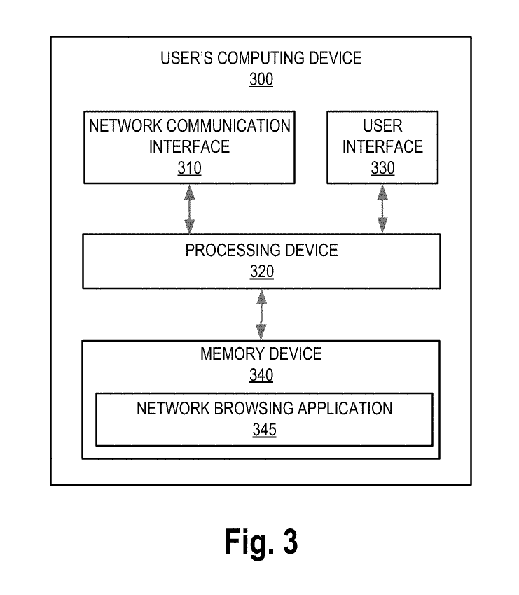

Referring now to FIG. 3, the user's computing devices 300, 301 associated with user 105 and plurality of users 110 also include various features, such as a network communication interface 310, a processing device 320, a user interface 330, and a memory device 340. The network communication interface 310 includes a device that allows the user's computing devices 300, 301 to communicate over the network 150 (shown in FIG. 1). In one embodiment of the invention, a network browsing application 345 provides for a user to establish network communication with a financial system server 200 (shown in FIG. 1) for the purpose of initiating enrollment in the transaction program, interacting with a device transaction interface, inputting data indicative of actions associated with one or more smart contracts and/or managing transactions, in accordance with embodiments of the invention.

As used herein, “transaction information” may include both monetary and non-monetary transaction information and records. Non-monetary transaction information or records means historical transaction information such as account balances, account activity, misappropriation activity, purchase activity, payment activity and the like and is distinguished from the underlying monetary transactions such as settling of accounts, payments, debits, credits, fund transfers and the like.

As used herein, a “processing device,” such as the processing device 320, generally refers to a device or combination of devices having circuitry used for implementing the communication and/or logic functions of a particular system. For example, a processing device 320 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 320 may further include functionality to operate one or more software programs based on computer-executable program code thereof, which may be stored in a memory. As the phrase is used herein, a processing device 320 may be “configured to” perform a certain function in a variety of ways, including, for example, by having one or more general-purpose circuits perform the function by executing particular computer-executable program code embodied in computer-readable medium, and/or by having one or more application-specific circuits perform the function.

The processing device 320 is configured to use the network communication interface 310 to communicate with one or more other devices on the network 150. The processing may interact with the processing devices of other devices on the network 150. The processing device 320 may control or give instructions to other devices on the network.

As used herein, a “user interface” 330 generally includes a plurality of interface devices and/or software that allow a user to input commands and data to direct the processing device to execute instructions. For example, the user interface 330 presented in FIG. 3 may include a graphical user interface (GUI) or an interface to input computer-executable instructions that direct the processing device 320 to carry out specific functions. The user interface 330 employs certain input and output devices to input data received from the first user 105 or second user 110 or output data to the first user 105 or second user 110. These input and output devices may include a display, mouse, keyboard, button, touchpad, touch screen, microphone, speaker, LED, light, joystick, switch, buzzer, bell, and/or other user input/output device for communicating with one or more users.

As used herein, a “memory device” 340 generally refers to a device or combination of devices that store one or more forms of computer-readable media for storing data and/or computer-executable program code/instructions. Computer-readable media is defined in greater detail below. For example, in one embodiment, the memory device 340 includes any computer memory that provides an actual or virtual space to temporarily or permanently store data and/or commands provided to the processing device 320 when it carries out its functions described herein. In some embodiments, resource data, merchant profile data, user account data and the like may be stored in a non-volatile memory distinct from instructions for executing one or more process steps discussed herein that may be stored in a volatile memory such as a memory directly connected or directly in communication with a processing device executing the instructions. In this regard, some or all the process steps carried out by the processing device may be executed in near-real-time, thereby increasing the efficiency by which the processing device may execute the instructions as compared to a situation where one or more of the instructions are stored and executed from a non-volatile memory, which may require greater access time than a directly connected volatile memory source. In some embodiments, one or more of the instructions are stored in a non-volatile memory and are accessed and temporarily stored (i.e., buffered) in a volatile memory directly connected with the processing device where they are executed by the processing device. Thus, in various embodiments discussed herein, the memory or memory device of a system or device may refer to one or more non-volatile memory devices and/or one or more volatile memory devices.

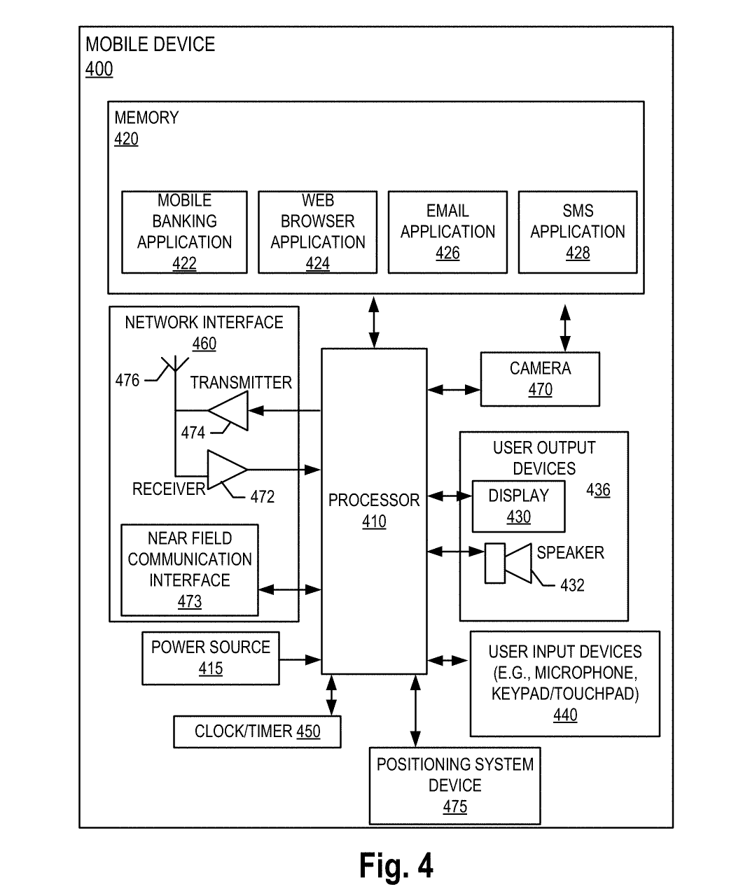

FIG. 4 provides a block diagram illustrating a mobile devices 400, 401 of FIG. 1 in more detail, in accordance with embodiments of the invention. In one embodiment of the invention, the mobile devices 400, 401 are a mobile telephone. However, it should be understood that a mobile telephone is merely illustrative of one type of mobile device 400, 401 that may benefit from, employ, or otherwise be involved with embodiments of the present invention and, therefore, should not be taken to limit the scope of embodiments of the present invention. Other types of mobile devices 400, 401 may include portable digital assistants (PDAs), pagers, mobile televisions, gaming devices, laptop computers, cameras, video recorders, audio/video player, radio, GPS devices, or any combination of the aforementioned.

Some embodiments of the mobile devices 400, 401 include a processor 410 communicably coupled to such devices as a memory 420, user output devices 436, user input devices 440, a network interface 460, a power source 415, a clock or other timer 450, a camera 470, and a positioning system device 475. The processor 410, and other processors described herein, generally include circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 424. The web browser application 424 may then allow the mobile device 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 260 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless telephone network 152. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The mobile device 400 may also be configured to operate in accordance with non-cellular communication mechanisms, such as via a wireless local area network (WLAN) or other communication/data networks.

As described above, the mobile device 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile device 400 to receive data from a user such as the first user 105, may include any of a number of devices allowing the mobile device 400 to receive data from a user, such as a keypad, keyboard, touch-screen, touchpad, microphone, mouse, joystick, other pointer device, button, soft key, and/or other input device(s). The user interface may also include a camera 470, such as a digital camera.

The mobile device 400 may also include a positioning system device 475 that is configured to be used by a positioning system to determine a location of the mobile device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 400. In other embodiments, the positioning system device 475 includes a proximity sensor or transmitter, such as an RFID tag, that can sense or be sensed by devices known to be located proximate a merchant or other location to determine that the mobile device 400 is located proximate these known devices. Such information may be used by embodiments of the invention in order to demonstrate completion or partial completion of one or more activities associated with a smart contract.

The mobile device 420 further includes a power source 415, such as a battery, for powering various circuits and other devices that are used to operate the mobile device 400. Embodiments of the mobile device 400 may also include a clock or other timer 450 configured to determine and, in some cases, communicate actual or relative time to the processor 410 or one or more other devices.

The mobile device 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the mobile device 400 and/or one or more of the process/method steps described herein. For example, the memory 420 may include such applications as a mobile banking application 422, a conventional web browser application 424, Email application 426 and/or a SMS application 428. These applications also typically provide a graphical user interface (GUI) on the display 430 that allows the first user 105 to communicate with the mobile device 400, the financial system server 200, and/or other devices or systems. In other embodiments of the invention, the first user 105 interacts with the financial system server 200 via the web browser application 424 and/or mobile banking application 422.

The memory 420 can also store any of a number of pieces of information, and data, used by the mobile devices 400, 401 and the applications and devices that make up the mobile devices 400, 401 or are in communication with the mobile devices 400, 401 to implement the functions of the mobile devices 400, 401 and/or the other systems described herein. For example, the memory 420 may include such data as user authentication information, or the like.

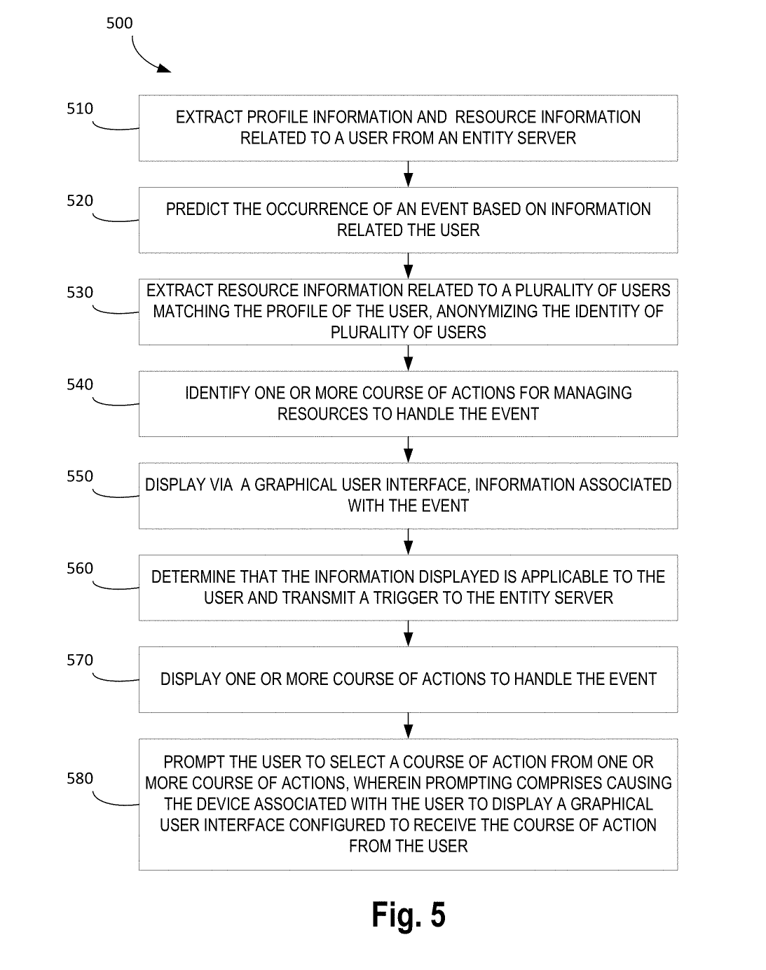

FIG. 5 illustrates a process flow for providing the user of a financial institution, event related data extracted from data associated with a plurality of users matching the profile of the user 500, in accordance with some embodiments of the invention. As shown in block 510, the process 500 is initiated upon system extraction of profile information and resource information related to the user from an entity server. In some embodiments, the entity server may comprise a financial system server. In some embodiments, the system accesses the resource information of the user by accessing the database in the memory device of the financial system server. For example, the system accesses the spending habits, monthly income, payments, loans, and the like of the user. In some embodiments, the system accesses the resource information related to the user only after receiving authorization from the user. For example, the system determines if the user would like to participate in releasing the resource information to allow the financial institution to gather information and analyze the data to provide recommendations about managing and utilizing resources to the users of the financial institution to help them handle the life events and/or life changes. In some embodiments, the user may opt to release the data only from one account associated with the user. For example, a user can have one or more accounts including savings account, checking account, money market account, retirement account, and the like and the user may opt to release the financial activity data associated with the checking account. In some embodiments, the user may opt to release the data from all the accounts associated with the user. For example, a user may opt to release the financial activity data related to all the accounts associated with the user including savings account, checking account, money market account, retirement account, and the like.

As illustrated in block 520, the system predicts the occurrence of an event based on the information related to the user, wherein the event refers to life event and/or a life change. For example, life events include marriage, child birth and the like and life changes include change of location, change of job, transitioning from student life to first job and the like. In some embodiments, the system analyzes the data extracted in block 510 to predict the occurrence of a life event and/or a life change by making an educated guess. For example, if the financial activity data has a set of transactions indicating payment to a wedding planner, payment to a venue or the like, the system recognizes that the user is getting married. In some embodiments, the system uses confidence scoring to predict the occurrence of an event. In other embodiments, the system prompts the user to input the occurrence of an event. For example, the system prompts the user to input any upcoming events or select from a list of events presented to the user. In some other embodiments, the system prompts the user to provide the purpose of the account by generating a questionnaire. For example, the system determines the purpose of the account by prompting the user to answer a series of questions generated by the system.

In some embodiments, the financial activity of all the accounts associated with each user of the financial entity is stored in the customized database tables in the memory device of the entity server. The system extracts the financial activity information related to the plurality of users associated with the financial entity from the customized database tables. For example, the financial activity data including debit transactions, credit transactions, and the like associated with all accounts including savings account, checking, and the like of each user of the financial entity, is stored in the customized database tables.

Next, as shown in block 530, the system extracts resource information related to a plurality of users associated with the entity matching the profile information of the user. Wherein the entity is a financial institution. Furthermore, as illustrated in block 520, the system as it extracts the resource information, anonymizes the users. In some embodiments, the system anonymizes the users by deliberate non-query of identity information from the customized database table and thus anonymizing the identity of the user. For example, the system extracts the financial activity data from the database tables by the method of querying using a query language such as SQL, PL/SQL, and the like and while extracting the resource information related to a plurality of users, the system excludes querying of the identity of the plurality of users. In some embodiments, the system accesses the resource information of a plurality of users associated with the financial institution matching the profile of the user after predicting the occurrence of an event. For example, the financial institution accesses the spending habits, monthly income, payments, loans, and the like of a plurality of users enrolled in the system present in the database of the financial system server. In some embodiments, the system extracts the resource information related to a plurality of users only after receiving authorization from the plurality of users associated with entity. For example, the system determines if the users enrolled in the system would like to participate in releasing the personal financial activity data to allow the financial institution to gather information and analyze the data to provide recommendations to the users of the financial institution to help them handle the life events and/or life changes. In some embodiments, the plurality of users may opt to release the data only from one account. For example, the plurality of users can have one or more accounts including savings account, checking account, money market account, retirement account, and the like and the user may opt to release the financial activity data associated with the checking account. In some embodiments, the plurality of users may opt to release the data from all the accounts. For example, the plurality of users may opt to release the financial activity data related to all the accounts including savings account, checking account, money market account, retirement account, and the like. In some embodiments, the system uses the extracted resource information related to a plurality of users matching the profile of the user to provide information to the user about spending, saving and investing habits of the plurality of users and the method of tracking their goals. For example, the system identifies the goals the users set and their spending habits like number of trips to a coffee shop and saving habits like decreasing the number of trips to a coffee shop for saving towards the goal. In some embodiments, the system also advises the users about altering the spending habits. For example, the user has a student loan that he/she is paying for, the system displays via a graphical user interface to the user, by decreasing the number of coffee shop visits from five times a week to three times a week will help reaching the goal of paying the student loan faster.

Next as shown in block 540, the system identifies one or more course of actions for managing resources to handle the event. In some embodiments, the system identifies the course of actions by analyzing the extracted data related to a plurality of users. The system, after predicting the occurrence of an event, analyzes the resource information extracted related to the plurality of users to identify one or more course of actions for managing resources performed by the plurality of users who experienced the predicted event. For example, if the predicted event is marriage, the system identifies plurality of users who experienced marriage and a course of steps taken by the plurality of users to manage the expenses and/or investing the income and the like. In some embodiments, the system directly extracts the course of actions from one or more database tables. The system identifies common events experienced by a plurality of customers, extracts one or more course of actions implemented by the plurality of customers and stores the extracted data associated with the common events in one or more database tables different from the customized database tables used for storing financial activity of each user. For example, the system stores the identified course of actions for managing resources which were successful to handle a child birth. In some embodiments, the system sorts the financial activity data related to course of actions for managing resources before storing the data in the database of the entity server. For example, the system sorts the extracted data according to the income level, age group, location of the user, and the like and stores the sorted data in one or more database tables.

As shown in block 550, the system displays, via a graphical user interface, information associated with the event, wherein the information associated with the event is type of event predicted. The information associated with the event is based on the retrieved resource information related to the user, wherein the resource information is extracted from the database of the financial system server. In some embodiments, the system also displays the information related to the user that is causing the event. For example, the system displays via a graphical user interface, the occurrence of marriage in the near future and the resource information including transaction data that caused the prediction of marriage. In some embodiments, the system displays the information associated with the event after identifying an online banking session. For example, the system identifies that the user has initiated an online banking session by logging in using the user credentials and displays the information related to the predicted event. In some embodiments, the user is allowed to choose the type of alerts that he/she would like to receive. For example, the user may limit the type of alerts or display of information related to life events such as financial crisis.

Next as shown in block 560, the system determines that the information is applicable to the user and transmits a trigger to the entity server. In some embodiments, the system determines if the prediction is applicable to the user based on the alert and the information displayed to the user. For example, the system prompts the user to determine whether the occurrence of the predicted event is valid based on the displayed information and transmits a trigger to the entity server. In some embodiments, the system after displaying the information related to the predicted event, the system prompts the user via a graphical user interface, a series of questions to determine that the displayed information is applicable to the user. This improves the accuracy of serving the user with correct course of actions for managing resources. For example, from the resource information related to the user like the payment to a wedding event planner the system predicts the occurrence of marriage in the near future. Before presenting the course of actions to the user, the system determines whether the prediction is true after displaying the cause of prediction by asking the user if the payment to the wedding event planner was for a personal purpose or was on behalf of another person related to the user.

In some embodiments, after determining that the information is applicable to the user, the system further prompts the user to determine if the predicted event is followed by any other event and repeats the process in blocks 520-560. For example, the event marriage may be followed by another event and/or a life change such as moving to a new house. The system prompts the user to input any events and/or life changes that follow the predicted life event and repeats the process of retrieving information related to the plurality of users and one or more course of actions

As shown in block 570, in response to receiving the trigger based on determining that the information displayed is applicable to the user, the system displays one or course of actions for managing resources to handle the event, wherein the one or more course of actions are extracted from one or more database tables. In some embodiments, the course of actions of certain events are already existing in the database tables. For example, the system extracts course of actions taken by plurality of users for most occurring life events and/or life changes as shown in blocks 530 and 540 and displays the extracted course of actions to the user. This reduces the processing time as the data is already sorted according to the type of life events and life changes and also according to different user profiles such as age group, location, job type and the like. The system matches the profile of the user with different user profiles and extracts the corresponding course of actions listed under the user profiles. In other embodiments, the course of action data related to certain life events and/or life changes doesn't exist in the database. For example, if the course of action for certain events and/or changes is listed in the database, the system compiles the list of course of actions on the go by following the steps mentioned in block 520 and 530.

As shown in block 580, the system prompts the user to select a course of action form one or more course of actions, wherein prompting comprises causing the device associated with the user to display a graphical user interface configured to receive the course of action from the user. In some embodiments, the system also predicts the possible outcomes for each course of action presented to the user before prompting the user to select a course of action. For example, the system represents graphically, outcomes of each course of action including displaying the success rate and the like.

In some embodiments, the system performs a series of steps associated with the course of action. For example, when the predicted event is child birth, the course of actions selected by the user may include opening an account or enrolling in a college savings plan for the new child, the system performs the steps of opening an account, enrolling in a college savings plan and the like.

In some other embodiments, the present invention identifies an existing event form the resource information related to the user extracted in block 510 and identifies a plurality of users who experienced the event. The system then extracts the resource information related to the identified plurality of users as explained in block 530 and identifies one or more course of actions as explained in block 540. The system displays via a graphical user interface, the identified one or more course of actions as explained in block 570 and prompts the user to select a course of action from one or more course of actions presented to the user, wherein prompting comprises causing the device associated with the user to display a graphical user interface configured to receive the course of action from the user as explained in block 580. The system after receiving the course of action from the user, performs a series of steps associated with the course of action selected by the user. For example, the system identifies a mortgage payment scenario based on the extracted resource information related to the user, identifies a group of plurality of users matching the profile of the user and identifies the mortgage payment scenario faced by the plurality of users and a series of measures executed by the plurality of users to handle the mortgage payment scenario from the resource information related to the plurality of users. The system then prompts via a graphical user interface the series of measures executed by the plurality of users to handle the mortgage payment.

In some embodiments, the system provides a holistic view of the entire financial life of the user and provides a vision into what user's life would like look if the user utilized the resources in a different way. The model may use the extracted data related to a plurality of users matching the profile of the user to present to the user, results achieved by the plurality of users in a scenario applicable to the user and the actions which led to the results. For example, the system identifies a mortgage payment scenario the user experienced in the past from the data extracted related to the user in block 510 and provides results achieved by performing a series of steps by a plurality of users like investing the resources achieved by savings which led to the quick repayment of mortgage. The system identifies the series of steps performed by a plurality of users from the data extracted in block 530.

The process of tracking, managing and utilizing the resources improves the functioning of an entity as the system provides a solution to help the users of the entity to better manage and utilize the resources which eliminates the process of reallocation of resources and overriding of data records related to the reallocation process. The entity has a huge volume of data related to utilization and management of resources, the system utilizes the already existing data to provide useful information to the users of the entity.

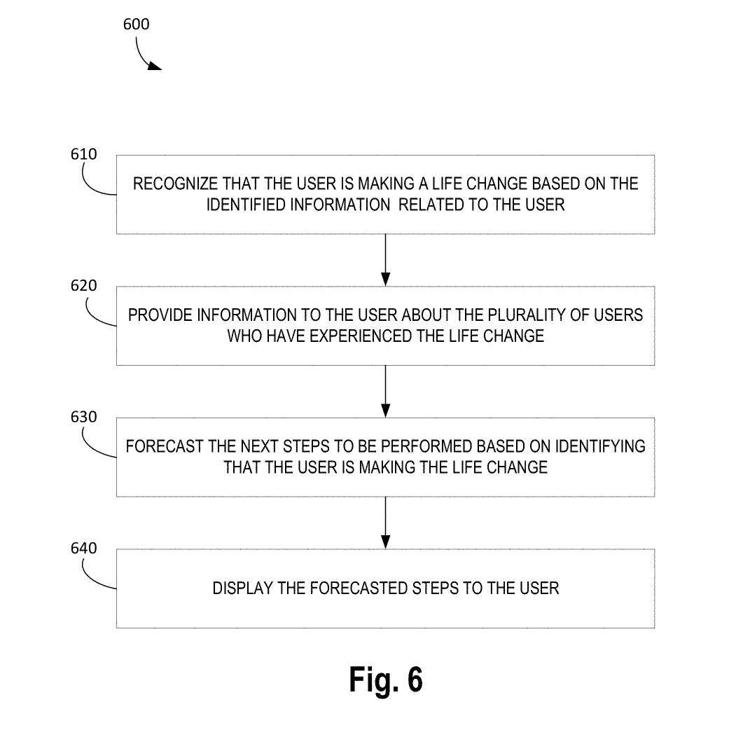

FIG. 6 illustrates a process flow for forecasting a series of steps to be performed based on identifying that the user is making a life change 600, in accordance with some embodiments of the invention. In block 610, the system recognizes the user is making a life change based on the identified information related to the user. The system recognizes the life changes including change of location, change of job, transitioning from student life to first job and the like based on the financial activity data extracted from the customized database tables having the financial activity data of each user. For example, the financial activity data has a set of transactions such as transaction indicating receiving first salary from a company or the like, the system recognizes that the user is transitioning from college to first job. In another example, if the financial activity data has a set of transactions indicating payment to realtors, payment to movers or the like, the system recognizes that the user is relocating to a new city. In some embodiments, confidence scoring is used to recognize that the user is making the life change.

As shown in block 620, the system provides information to the user about the plurality of users who have experienced the life change. In some embodiments, the system has the data about the measures taken by the users to transition without difficulty. For example, if the system determines that the user has his first job and has taken an education loan previously, the system provides information about a plurality of users who experienced the same transition and were successful in repaying the loan efficiently. In some embodiments, the system extracts information about a plurality of users who experienced common life changes and stores the information in one or more database tables. For example, the system extracts information about a plurality of users matching the profile of the user who experienced transition between jobs and stores it in the database for easy retrieval of data upon recognizing that the user is transitioning between jobs. In some embodiments, the system stores the extracted information related to a plurality of users based on different use profiles such as age group, job type, job industry and the like reducing the processing time for extraction of data to present it to the user. In other embodiments, the system does not store information related to life changes in the database. Instead, the system compiles the data after determining that the user is making a life change.

Next, as shown in block 630, the system forecasts the next steps to be performed based on identifying that the user is making the life change. For example, if the user is moving to a new city, the system predicts all the steps to be performed including updating residence address in employee portal, setting up electricity, internet and the like. In some embodiments, the system forecasts the next steps to be performed by the user based on extracted information. For example, if the user is moving to a new city, the system predicts all the steps to be performed including updating residence address in employee portal, setting up electricity, internet and the like. For example, if the user is moving to a new job, the system predicts all the steps to be performed based on the extracted information related to a plurality of users matching the profile of the user.

As shown in block 640, the system displays the forecasted steps to the user. In some embodiments, the system alerts the user about the forecasted steps to be performed by the user. For example, the system sends alerts to the user about the steps to be performed, to the device associated with the user. In some embodiments, the system alerts the user about the forecasted steps to be performed based on determining the location of the user. For example, if the system recognizes that the user is moving to a new city and based on the location of the user, for instance if the user is near the post office, the system reminds the user about adding a forwarding address. In some embodiments, the system presents a check list to the user listing all the steps to be performed before making the life change. For example, the system creates an interactive check list, using which the user can keep track of steps which are yet to be performed. In some embodiments, the system allows the user to share the check list with other users. For example, the system allows the user to share the checklist with the user's life partner or the like. In some embodiments, the system allows the user to limit the use of check list by a secondary user. For example, the user can limit the usage of check list by restricting the secondary user from editing the checklist.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as a system (including, for example, an system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other systems. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of system and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing system in order to produce a particular machine, such that the one or more computer-executable program code portions, which execute via the processor of the computer and/or other programmable data processing system, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing system to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing system to cause a series of operational steps to be performed on the computer and/or other programmable system. In some embodiments, this produces a computer-implemented process such that the one or more computer-executable program code portions which execute on the computer and/or other programmable system provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent application | | |
|---|---|---|---|
| Docket Number | Ser. No. | Title | Filed On |
| 7261US1.014033.2851 | To be assigned | RESOURCE ASSIGNMENT | Concurrently |
| | | SYSTEM | herewith |
| 7262US1.014033.2852 | To be assigned | RESOURCE ASSIGNMENT | Concurrently |
| | | SYSTEM WITH | herewith |
| | | ALLOCATION ASSIST | |
| 7263US1.014033.2853 | To be assigned | SYSTEM FOR RESOURCE | Concurrently |
| | | ALLOCATION AT TIME OF | herewith |
| | | USE AND CONSERVATION | |
| | | OF UNUSED PORTION | |
| 7264US1.014033.2854 | To be assigned | SYSTEM FOR RESOURCE | Concurrently |
| | | ALLOCATION AND | herewith |
| | | CONSERVATION OF | |
| | | UNUSED PORTION | |
| 7265US1.014033.2855 | To be assigned | SYSTEM FOR | Concurrently |
| | | MONITORING RESOURCE | herewith |
| | | ACTIVITY AND ALERT | |
| | | GENERATION | |

What is claimed is:

1. A system for resource tracking and predictive utilization, the system comprising:
a network communication interface;
a memory device storing a resource tracking and utilization application;
a processing device operatively coupled to the memory device, wherein the processing device is configured to execute computer-readable program code to:
extract from an entity server, profile information and resource information related to a user associated with an entity, wherein the information is extracted with authorization from the user;
predict the occurrence of an event based on the extracted information related to the user;
retrieve from a customized database table in the entity server, resource information related to a plurality of users associated with the entity matching profile information of the user, wherein the information is extracted with authorization from the plurality of users, wherein the identity of the plurality of users is anonymized by deliberate non-query of identity information from the customized database table;
identify a one or more course of actions for managing resources to handle the event based on the resource information retrieved related to the plurality of users;
display, via a graphical user interface, information associated with the event based on the retrieved resource information related to the user, wherein the information associated with the event is type of the event;
determine that the information displayed is applicable to the user and transmit a trigger to the entity server; and
in response to receiving the trigger based on determining that the information displayed is applicable to the user, display the identified one or more course of actions;
prompt, via the computer processing device, the user to select a course of action from the one or more course of actions provided, wherein prompting the user comprises causing the device associated with the user to display a graphical user interface that is configured to receive the course of action from the user.

2. The system of claim 1, wherein in response to receiving the course of action from the user, initiating the course of action by performing a series of steps associated with the course of action.

3. The system of claim 1, wherein the processing device is further configured to execute computer-readable program code to display the outcome of the one or more course of actions.

4. The system of claim 1, wherein the processing device is further configured to execute computer-readable program code to:
recognize that the user is making a life change based on the identified information related to the user;
provide information to the user about the plurality of users who have experienced the life change.

5. The system of claim 4, wherein confidence scoring is used to recognize that the user is making the life change.

6. The system of claim 4, wherein the processing device is further configured to execute computer-readable program code to forecast a series of steps to be performed based on identifying that the user is making the life change.

7. The system of claim 1, wherein the entity retrieves information from the user by generating a questionnaire to identify a purpose of the account.

8. The system of claim 1, wherein the processing device is further configured to execute computer-readable program code to provide a holistic view of the financial life of the user,

9. The system of claim 1, wherein the processing device is further configured to execute computer-readable program code to:
identify a mortgage payment scenario, based on the extracted resource information related to the user;
identify a group of the plurality of users, matching the profile of the user;
identify the mortgage payment scenario faced by the plurality of users and a series of measures executed by the plurality of users to handle the mortgage payment scenario from the resource information related to the plurality of users;
prompt to the user, via a graphical user interface the series of measures executed by the plurality of users to handle the mortgage payment.

10. A computer program product for resource tacking and predictive utilization, the computer program product comprising at least one non-transitory computer-readable medium having computer-readable program code portions embodied therein, the computer-readable program code portions comprising an executable portion of code configured to:
extract from an entity server, profile information and resource information related to a user associated with an entity, wherein the information is extracted with authorization from the user;
predict the occurrence of an event based on the extracted information related to the user;
retrieve from a customized database table in the entity server, resource information related to a plurality of users associated with the entity matching profile information of the user, wherein the information is extracted with authorization from the plurality of users, wherein the identity of the plurality of users is anonymized by deliberate non-query of identity information from the customized database table;
identify a one or more course of actions for managing resources to handle the event based on the resource information retrieved related to the plurality of users;
display, via a graphical user interface, information associated with the event based on the retrieved resource information related to the user, wherein the information associated with the event is type of the event;
determine that the information displayed is applicable to the user and transmit a trigger to the entity server; and
in response to receiving the trigger based on determining that the information displayed is applicable to the user, display the identified one or more course of actions;
prompt, via the computer processing device, the user to select a course of action from the one or more course of actions provided, wherein prompting the user comprises causing the device associated with the user to display a graphical user interface that is configured to receive the course of action from the user.

11. The computer program product of claim 10, wherein in response to receiving the course of action from the user, initiating the course of action by performing a series of steps associated with the course of action.

12. The computer program product of claim 10, wherein the processing device is further configured to execute computer-readable program code to display the outcome of the one or more course of actions.

13. The computer program product of claim 10, wherein the processing device is further configured to execute computer-readable program code to:
recognize that the user is making a life change based on the identified information related to the user; and
provide information to the user about the plurality of users who have experienced the life change.

14. The computer program product of claim 13, wherein confidence scoring is used to recognize that the user is making the life change.

15. The computer program product of claim 13, wherein the processing device is further configured to execute computer-readable program code to forecast a series of steps to be performed based on identifying that the user is making the life change.

16. The computer program product of claim 10, wherein the entity retrieves information from the user by generating a questionnaire to identify a purpose of the account.

17. The computer program product of claim 10, wherein the processing device is further configured to execute computer-readable program code to provide a holistic view of the financial life of the user.

18. A method for resource tracking and predictive utilization, the method comprising:
extracting from an entity server, profile information and resource information related to a user associated with an entity, wherein the information is extracted with authorization from the user;
predicting the occurrence of an event based on the extracted information related to the user;
retrieving from a customized database table in the entity server, resource information related to a plurality of users associated with the entity matching profile information of the user, wherein the information is extracted with authorization from the plurality of users, wherein the identity of the plurality of users is anonymized by deliberate non-query of identity information from the customized database table;
identifying a one or more course of actions for managing resources to handle the event based on the resource information retrieved related to the plurality of users;
displaying, via a graphical user interface, information associated with the event based on the retrieved resource information related to the user, wherein the information associated with the event is type of the event;
determining that the information displayed is applicable to the user and transmit a trigger to the entity server; and
in response to receiving the trigger based on determining that the information displayed is applicable to the user, display the identified one or more course of actions;
prompting, via the computer processing device, the user to select a course of action from the one or more course of actions provided, wherein prompting the user comprises causing the device associated with the user to display a graphical user interface that is configured to receive the course of action from the user.

19. The method of claim 18, wherein the method further comprises:
recognize that the user is making a life change based on the identified information related to the user; and
provide information to the user about the plurality of users who have experienced the life change.

20. The method of claim 18, wherein the method further comprises forecasting a series of steps to be performed based on identifying that the user is making the life change.
